(19) United States
(12) Patent Application Publication
(10) Pub. No.: US 2004/0035462 A1
(43) Pub. Date: Feb. 26, 2004

(54) Integral control valve and actuator

(76) Inventors: Michael W. McCarty, Marshalltown, IA (US); Douglas P. Gethmann, Gladbrook, IA (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/224,169

(22) Filed: Aug. 20, 2002

(51) Int. Cl. F16K 1/00

(52) U.S. Cl. 137/219

(57) ABSTRACT

A combined, integral flow control valve and actuator is formed with a two part valve body and a slidable plug therebetween. A valve seat is formed integrally within the valve body. The slidable plug and the valve body define actuating chambers. A positioner/actuator mounted to the valve body has an output coupled to the actuator chamber to move the slidable plug with respect to the valve seat and thereby control fluid flow. In a single action device, a spring return moves the slidable plug towards the valve seat. In a dual acting embodiment, two actuating chambers are provided and two integral valve seats are provided in a symmetrical configuration. The valve seat is removable enabling different materials to be used for the valve seat.

This invention relates to axial flow control valves, and in particular to a flow control valve with an integral positioner/actuator.

### BACKGROUND OF THE INVENTION

Flow control valves are in common use in pipeline systems, process control systems, etc. for controlling the flow of fluids in response to valve actuators/positioners which actuate and position the control valve to provide a desired fluid flow. Various types of control valves are available wherein a valve shaft is rotated or a valve stem is slidable by a separate, external actuator/positioner unit. Typically, the actuator output is connected to the shaft or stem to correspondingly position a flow control member (such as a plug) mounted to one end of the shaft or stem. Feedback sensing is used to position the plug with respect to a valve seat to control the fluid flow through the valve.

It is desired to provide a unique flow control valve structure which can be combined with an integral actuator and which can be readily adapted to either single acting or dual acting and which also can readily accommodate, if desired, an integral pressure reduction device.

### SUMMARY OF THE INVENTION

In accordance with the present invention there is provided a combined, integral flow control valve and actuator which can be readily provided in a dual acting unit, and with a pressure reduction device if desired.

In particular, there is provided a unique flow control valve and integral actuator, which in accordance with the principles of the present invention can provide the following features:

1. An axial flow control valve with integrated plug and seating surface in the valve body, and which can readily be provided with a dual plug and seating surface;

2. An in-line integral actuator accommodates double acting or spring return actions;

3. The seating surface can be readily changed to accommodate soft seats, metal seats, or a combination of each;

4. The valve plug can accommodate different contours for different desired flow characteristics for different process control logic or at different operating conditions, without removing the valve from the process system;

5. Various special design inserts for noise and cavitation applications, such as a pressure reduction device can readily be added;

6. A symmetrical sliding sleeve accommodates seating surfaces at both valve ends, thereby providing a spare seat if the primary seat is damaged by closing against the opposing plug; and

7. Installation of the control valve is symmetric and reversible, therefore the valve can be installed in either direction to eliminate installation errors.

One embodiment of the present invention provides a combined, integral fluid flow control valve and valve actuator including a valve body having opposite valve input and valve output ports and a valve passageway therebetween and with a valve seat integral with the valve body intermediate the valve input port and the valve passageway. A slidable plug is mounted in the valve body within the valve passageway and is movable towards and into fluid sealing contact with the valve seat for controlling the flow of fluid to the valve output port. At least one portion of the plug and an opposite portion of the valve body define an actuating chamber. A positioner/actuator is mounted to the valve body and includes an actuator output coupled to the actuating chamber for slidably moving the plug with respect to the valve seat.

### BRIEF DESCRIPTION OF THE DRAWINGS

The features of this invention which are believed to be novel are set forth with particularity in the appended claims. The invention may be best understood by reference to the following description taken in conjunction with the accompanying drawings, in which like reference numerals identify like elements in the several figures and in which:

FIG. 1 is a cross-sectional view of a constructed embodiment of an axial sleeve valve with an integral actuator in accordance with the principles of this invention;

FIG. 2 is a schematic drawing illustrating an axial sleeve valve with an integral actuator and dual characteristics in accordance with the principles of the present invention; and

FIG. 3 is a schematic drawing illustrating an axial sleeve valve with an integral actuator in a single acting device with an added pressure reduction device.

### DETAILED DESCRIPTION

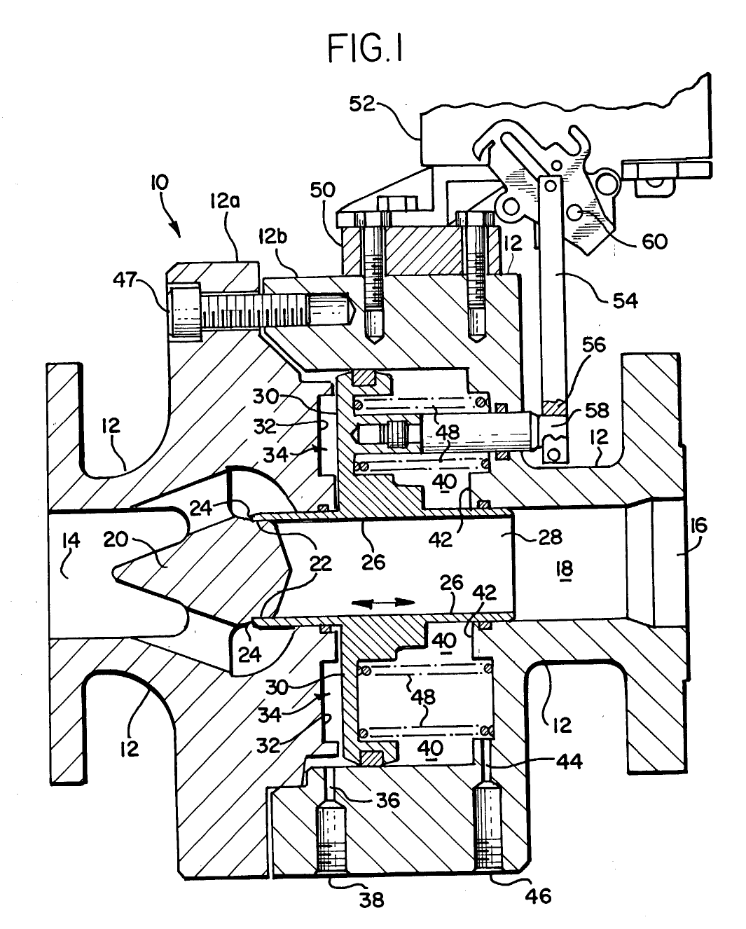

Referring now to FIG. 1, there is illustrated a combined, integral axial flow control valve and actuator 10 which includes a valve body 12 having a valve input 14 and an opposite valve output 16 both of which are interconnected by a valve passageway 18 which can accommodate fluid flow from the valve inlet 14 to the valve outlet 16 under control of the valve 10. Within the valve body passageway 18 there is provided a valve seat base 20 formed integrally with the valve body 12, and with the valve seat base including a valve seat 22 which is sealingly engageable by a plug end 24 of a slidable plug 26 to control fluid flow through the valve. That is, when the slidable plug 26 is in the position shown in FIG. 1, with the plug end 24 sealingly engaging the valve seat 22, fluid flow is prevented from passing from the valve inlet 14 to the valve outlet 16. However, when the slidable plug 26 is slidably actuated towards the right in FIG. 1 the plug end 24 becomes disengaged from the valve seat 22, thereby permitting fluid flow from inlet 14, passed the valve seat 22 and to the valve passageway 18, and continuing to the valve outlet 16.

The slidable plug 26 includes a cylindrical portion 28 having a cylindrical exterior surface matching the cylindrical interior surface of passageway 18. In addition, the slidable plug 26 also includes a projecting portion 30 extending from the cylindrical portion 28 and which is opposite to a valve body wall 32 to define an actuator chamber 34. The actuator chamber 34 fluidly communicates through a passageway 36 in the valve body 12 and extends to an actuator inlet 38 at the exterior valve body 12.

On the side opposite of the actuator chamber 34, the projecting portion 30 of plug 26 also defines another chamber 40 defined by the projecting portion 30 and a respective opposite valve body wall 42. A passageway 44 communicates the interior of chamber 40 to a port 46 on the valve body exterior.

As can be seen, the valve body is in two respective portions 12a and 12b joined by suitable bolts 47, with the slidable plug 26 moving therebetween. This enables one valve body part to be removed from the other to expose the interior of the valve and thereby enable the valve plug to be changed if desired to accommodate different contours for different desired flow characteristics for different process control logic or at different operating conditions, without removing the valve from the process system.

Within chamber 40 there is provided one or more springs 48 each with opposite spring ends engageably contacting the projecting plug portion 30 and the valve body 12. As seen in FIG. 1, the springs 48 function as return springs urging the slidable piston 26 towards the left so that the plug end 24 sealably engages the valve seat 22. Accordingly, actuator pressure at inlet 38 is coupled through passageway 36 into the actuator chamber 34 to move slidable plug 26 towards the right against the action of the springs 48. The air in the compressed volume of chamber 40 is vented out passageway 44 and through port 46 to the atmosphere.

A mounting platform 50 is suitably mounted to the valve body 12 to support a positioner/actuator 52 which in turn is mounted to the mounting platform 50 to combine the positioner/actuator with the flow control valve. A feedback arm 54 extends from the positioner/actuator 52 to an end 56 which is rigidly connected to one end of an extension arm 58 respectively having an opposite end threadably engaged within the projecting plug portion 30.

Accordingly, as the projecting plug portion 30 moves back and forth in position, the movement is tracked by the feedback arm 54 so as to rotate a position shaft 60 which thereby tracks the position of the slidable plug 26 within the positioner 52. Thus, as the actuator output coupled to port 38 is coupled into the actuator chamber 34, the slidable plug 26 is moved and the plug movement is tracked through feedback arm 54 and rotating shaft 60 to indicate a plug position within positioner 52. The position of plug 26 can therefore be accurately positioned within the valve by means of the positioner/actuator 52 feedback controlling the actuator output coupled to port 38.

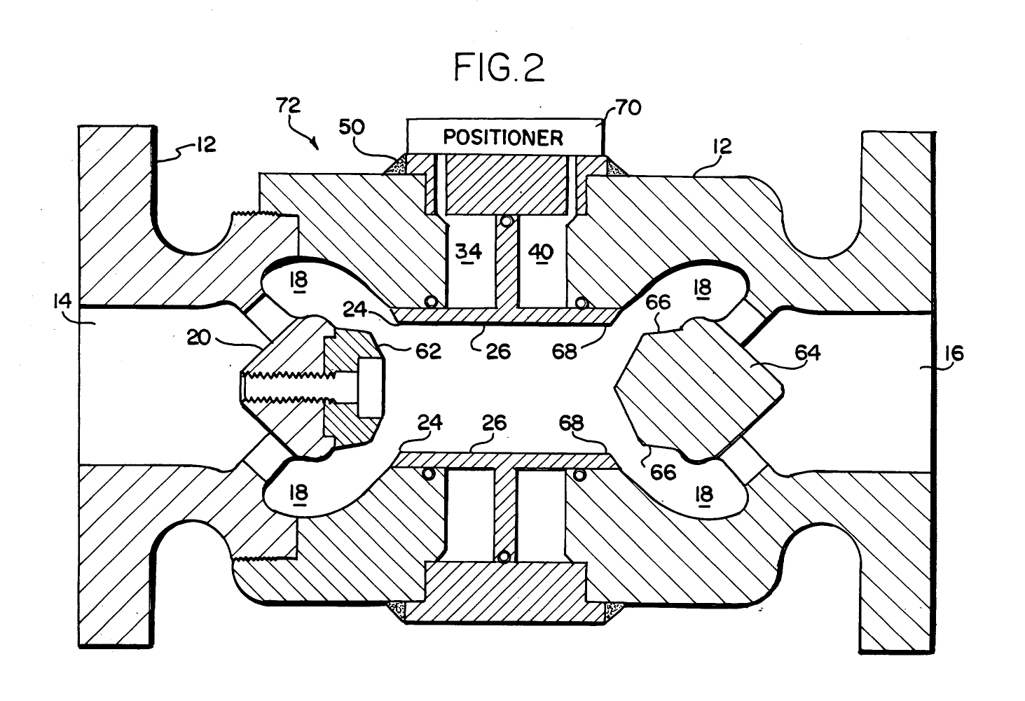

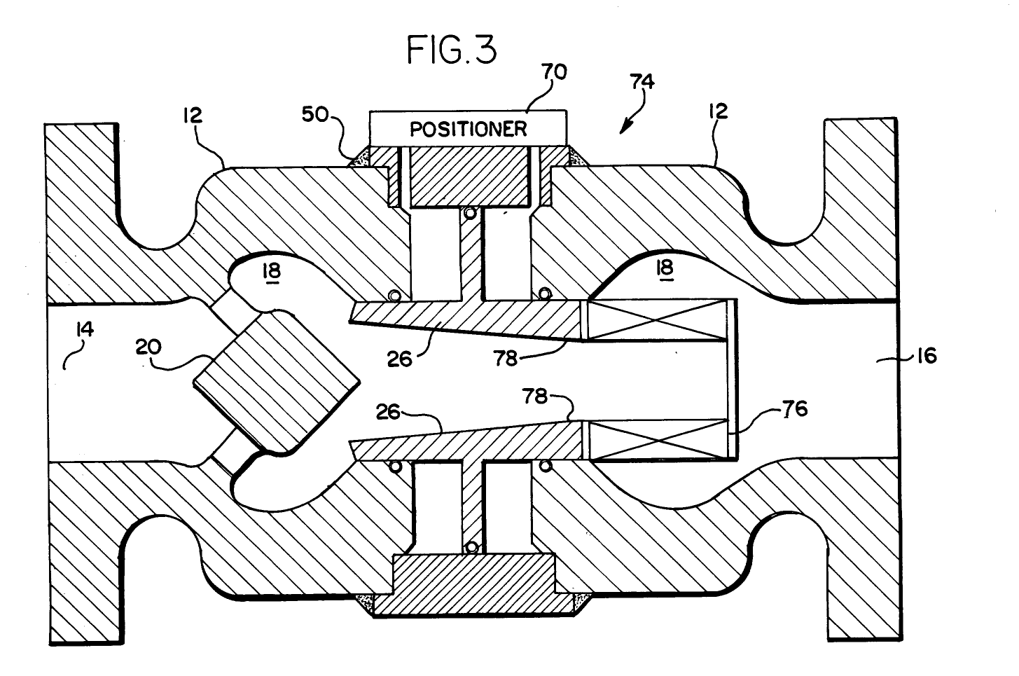

Referring now to FIGS. 2 and 3, further distinguishing features of the present invention are illustrated and may be described as follows. In the schematic illustration of FIG. 2, items which have already been described are indicated with the same reference numerals as previously described in connection with FIG. 1. In addition, it may be noted that the valve seat base 20 includes a removable valve seat 62. In particular, the valve seat 62 can be threadably mounted to the seat base as illustrated. Thus the valve seating surface can be readily changed to accommodate soft seats, metal seats, or a combination of each.

In addition, it may be noted that there is a second valve seat base 64 formed integrally with the valve body 12 between the passageway 18 and the valve outlet 16, and which includes a respective valve 66. A plug end 68 opposite to plug end 24 is provided on the slidable plug 26 so as to sealingly engage the valve seat 66.

Positioner/actuator 70 includes respective outputs which are coupled to actuating chamber 34 and to chamber 40 so that the slidable plug 26 can be moved both towards and away from valve seat 62 as well as towards and away from the second valve seat 66. Accordingly, a symmetrical sliding plug arrangement has been provided to accommodate seating surfaces at both valve ends, thereby providing a spare seat if the primary seat is damaged by closing against the opposing plug. Also, the installation of the combined control valve and actuator 72 shown in FIG. 2 is symmetric and reversable. Note the valve symmetry about the longitudinal axis passing through the centers of the valve input port 14 and output port 16. Therefore the valve can be installed in either direction and thereby eliminate possible installation errors.

Referring now to FIG. 3, there is schematically illustrated components of a combined valve/actuator 74 which contain similar reference numerals to those described previously. In the embodiment of FIG. 3, there has been included a pressure reduction device 76 mounted to end 78 of the slidable plug 26. Such pressure reduction devices are well known and commercially available as inserts in flow control valves and in pipelines for noise and cavitation reduction. In FIG. 3, such a pressure reduction device 76 is suitably mounted to the end 78 of the slidably plug 26 so that there has been provided a combined flow control valve, actuator and pressure reduction device.

The foregoing detailed description has been given for clearness of understanding only, and no unnecessary limitations should be understood therefrom, as modifications will be obvious to those skilled in the art.

What is claimed is:

1. A combined, integral fluid flow control valve and valve actuator comprising:
a valve body having opposite valve input and valve output ports and a valve passageway therebetween;
a valve seat intermediate the valve input port and the valve passageway;
a slidable plug slidably mounted in the valve body within the valve passageway and slidably movable towards and in fluid sealing contact with the valve seat to shut off the flow of fluid from the valve input to the valve output, and away from the valve seat for controlling the flow of fluid to the valve output port;
at least one portion of said slidable plug defining with an opposite portion of said valve body an actuating chamber; and
a positioner mounted to said valve body and including an actuator output coupled to said actuating chamber for slidably moving said plug with respect to said valve seat.

2. A combined, integral fluid flow control valve and valve actuator according to claim 1, including a spring mounted between the plug and the valve body to slidably move the plug with respect to the valve seat.

3. A combined, integral fluid flow control valve and valve actuator according to claim 1, wherein said plug includes a second plug portion defining with a respective opposite portion of said valve body a second actuating chamber

4. A combined, integral fluid flow control valve and valve actuator according to claim 3, including a second valve seat intermediate the valve output port and the valve passageway, wherein said slidable plug is slidably moved towards and in fluid sealing contact with the second valve seat to shut off the flow of fluid from the passageway to the valve output port, and away from the second valve seat for controlling the flow of fluid to the valve output port.

5. A combined, integral fluid flow control valve and valve actuator according to claim 1, including a pressure reduction device mounted to said slidable plug intermediate the valve passageway and the valve output port.

6. A combined, integral fluid flow control valve and valve actuator according to claim 1, wherein said valve seat is integral with said valve body.

7. A combined, integral fluid flow control valve and valve actuator according to claim 1, wherein said slidable plug is a cylindrically shaped plug with an exterior surface slidably adjacent said valve body and wherein said plug portion comprises an upstanding wall defining with said opposite portion of said valve body said actuating chamber therebetween.

8. A combined, integral fluid flow control valve and valve actuator according to claim 7, including a spring having one end mounted adjacent said upstanding wall opposite said actuating chamber and an opposite spring end engaging a respective portion of the valve body.

9. A combined, integral fluid flow control valve and valve actuator according to claim 7, including a pressure reduction device mounted to said slidable plug intermediate the valve passageway and the valve output port.

10. A combined, integral fluid flow control valve and valve actuator according to claim 7, including a second actuating chamber defined by the upstanding wall and the respective portion of the valve body opposite to the first mentioned actuating chamber, and said actuator includes a second actuator output coupled to said second actuating chamber to slidably move said plug with respect to said valve seat.

11. A combined, integral fluid flow control valve and valve actuator according to claim 10, wherein said slidable plug includes a first plug end engageable with said valve seat, and further comprising a second valve seat intermediate the valve output and the valve passageway, and a second plug end opposite said first plug end, wherein the slidable plug is slidably moved towards and in fluid sealing contact with the second valve seat to shut off the flow of fluid from the passageway to the valve output port, and away from the second valve seat for controlling the flow of fluid to the valve output port.

12. A combined, integral fluid flow control valve and valve actuator according to claim 1, wherein said valve seat includes a base portion integral with said valve body.

13. A combined, integral fluid flow control valve and valve actuator according to claim 12, wherein said valve seat further includes a seat sealing portion removably mounted to said base portion.

14. A combined, integral fluid flow control valve and valve actuator according to claim 1, wherein said valve body is formed by two valve body portions removably mounted together, one of said valve body portions including said valve seat, and wherein said slidable plug slidably moves within the other valve body portion and towards and away from said valve seat in said one valve body portion.

15. An integral axial flow control valve and valve actuator comprising:
a valve body having opposite valve input and valve output ports and a valve passageway therebetween;
a valve seat formed integral with the valve body and intermediate the valve input port and the valve passageway;
a slidable plug slidably mounted in the valve body within the valve passageway and slidably movable towards and in fluid sealing contact with the valve seat on said valve body to shut off the flow of fluid from the valve input to the valve output, and away from the valve seat for controlling the flow of fluid to the valve output port; and
at least one portion of said slidable plug defining with an opposite portion of said valve body an actuating chamber for slidably moving said plug with respect to said valve seat.

16. An integral axial flow control valve and valve actuator according to claim 15, wherein said plug includes a second plug portion defining with a respective opposite portion of said valve body a second actuating chamber for slidably moving said plug with respect to said valve seat.

17. An integral axial flow control valve and valve actuator according to claim 16, including a second valve seat intermediate the valve output port and the valve passageway, wherein said slidable plug is slidably moved towards and in fluid sealing contact with the second valve seat to shut off the flow of fluid from the passageway to the valve output port, and away from the second valve seat for controlling the flow of fluid to the valve output port.

18. An integral axial flow control valve and valve actuator according to claim 17, wherein there is symmetry about a longitudinal axis passing through the centers of said valve input and output ports.
